(19) United States
(12) Patent Application Publication
(10) Pub. No.: US 2026/0252599 A1
(43) Pub. Date: Aug. 27, 2026

(54) OPERATION SERVICE PROVIDING SYSTEM AND METHOD

(71) Applicant: Hitachi, Ltd., Tokyo (JP)

(72) Inventor: Yusuke KATO, Tokyo (JP)

(21) Appl. No.: 19/312,430

(22) Filed: Aug. 28, 2025

(30) Foreign Application Priority Data
Feb. 25, 2025 (JP) 2025-027759

(51) Int. Cl. G06F 16/3329

(52) U.S. Cl. CPC G06F 16/33295

(57) ABSTRACT

An operation service providing system 1 that provides a prescribed operation service includes an operation service execution unit 10 configured to control execution of the prescribed operation service, and an audit preparation unit 20 configured to execute a prescribed audit preparation work in preparation for an audit work for auditing whether the prescribed operation service is executed based on a prescribed standard. The audit preparation unit executes the prescribed audit preparation work for the prescribed operation service each time the operation service execution unit executes the prescribed operation service.

### CROSS-REFERENCE TO RELATED APPLICATION

The present application claims priority from Japanese application JP2025-027759, filed on Feb. 25, 2025, the content of which is hereby incorporated by reference into this application.

### BACKGROUND OF THE INVENTION

### 1. Field of the Invention

The present invention relates to an operation service providing system and method.

### 2. Description of Related Art

In a company or the like, an operation service such as network setting, account management, data backup, application of a security patch, or document management is periodically audited to confirm whether the operation service is being implemented in conformity with a standard such as international organization for standardization (ISO).

In the audit, whether the operation service conforms to requirements of the standard and whether the operation service is functioning to achieve a purpose are determined by audit evidences such as work evidence (Patent Literatures 1 to 3). As audit preparation, the company needs to collect audit evidences, organize compliance with each requirement, and check a corrective action status of a previous non-conformity. Therefore, the audit preparation takes time and effort for the company. Further, a single service may need to conform to a plurality of standards. Recent years have also seen multiple services that require compliance with the same standard. This increases the time and effort required for the audit preparation.

While distinct from the audit preparation, there is also known a technique of creating an answer to items in a business evaluation sheet employed in loan screening by financial institutions by a general-purpose natural language processing model (LLM) (Patent Literature 4).

### CITATION LIST

### Patent Literature

PTL 1: JP2007-200202A
PTL 2: JP2010-250738A
PTL 3: JP2012-073838A
PTL 4: JP2025-044097A

### SUMMARY OF THE INVENTION

The audit preparation can be efficiently performed in the related art. However, it is not possible to determine whether an operation service is executed in conformity with a standard when the operation service is executed, since the audit preparation and the operation service are separately carried out. Whether the operation service is executed in conformity with the standard is determined only when the audit preparation is performed after a certain period of time.

Further, a checklist is used in the audit preparation. It takes time for a person who performs the audit preparation to answer items of the checklist while confirming evidences in order to confirm whether the operation service complies with the standard.

The disclosure provides an operation service providing system and method that can assist audit preparation.

To solve the above problem, an operation service providing system according to the disclosure provides a prescribed operation service, the operation service providing system including: an operation service execution unit configured to control execution of the prescribed operation service; and an audit preparation unit configured to execute a prescribed audit preparation work in preparation for an audit work for auditing whether the prescribed operation service is executed based on a prescribed standard, in which the audit preparation unit executes the prescribed audit preparation work for the prescribed operation service each time the operation service execution unit executes the prescribed operation service.

According to the disclosure, it is possible to execute a prescribed audit preparation action for a prescribed operation service each time the operation service execution unit executes the prescribed operation service.

### BRIEF DESCRIPTION OF THE DRAWINGS

FIG. 1 is a functional configuration diagram showing functions of an operation service providing system;

FIG. 2 is a hardware structure diagram of the operation service providing system;

FIG. 3 is another hardware structure diagram of the operation service providing system;

FIG. 4 shows an example of an operation service management table;

FIG. 5 shows an example of contents stored in an evidence database;

FIG. 6 is a flowchart of overall processing executed by the operation service providing system;

FIG. 7 shows a flow of procedures when an operation service is used;

FIG. 8 shows a relationship between a checklist answer unit and an answer generation unit;

FIG. 9 shows an example of information input to the answer generation unit from the checklist answer unit;

FIG. 10 shows an example of information output to the checklist answer unit from the answer generation unit;

FIG. 11 shows an example of a template for a checklist;

FIG. 12 shows an example of a checklist;

FIG. 13 shows procedures for extracting a keyword from a check content of a checklist and executing an action associated with the extracted keyword;

FIG. 14 shows an example of outputting a checklist answer, which is an action execution result created in the procedures shown in FIG. 13, associated with an evidence;

FIG. 15 shows other procedures for extracting a keyword from a check content of a checklist and executing an action associated with the extracted keyword;

FIG. 16 shows an example of outputting a checklist answer, which is an action execution result created in the procedure shown in FIG. 15, associated with an evidence;

FIG. 17 shows an example of procedures for generating a checklist answer including an action to be executed and an evidence that is a basis;

FIG. 18 shows an example of a checklist answer generated according to the procedures shown in FIG. 17;

FIG. 19 shows an example of a template for a checklist;

FIG. 20 shows an example of a checklist;

FIG. 21 shows an example of an answer result of a checklist;

FIG. 22 shows an example of an operation service management table according to Embodiment 2;

FIG. 23 shows an example of an action table;

FIG. 24 shows an example of a management database;

FIG. 25 is a flowchart showing processing for adding a standard; and

FIG. 26 shows a flow of use procedures of an operation service according to Embodiment 3.

### DESCRIPTION OF EMBODIMENTS

Hereinafter, embodiments of the invention will be described with reference to the drawings. An operation service providing system according to the embodiments executes an operation service with high reliability. The operation service providing system according to the embodiments executes the operation service while executing audit preparation. The operation service providing system according to the embodiments can prepare for an audit of the operation service while confirming that the operation service is executed in conformity with a standard.

Hereinafter, an audit evidence may be abbreviated as an evidence. The operation service may be replaced with operation work.

The operation service includes management or control of an information processing infrastructure, start-up or shut-down of the system, data backup, log acquisition, addition or deletion of a user account, application of a server patch, storage and delivery of a memory medium and a computer, and the like. In the embodiments, examples of the operation service include incident management, password management, update of a secure sockets layer (SSL) certificate, backup of data, periodic maintenance, and service monitoring.

### Embodiment 1

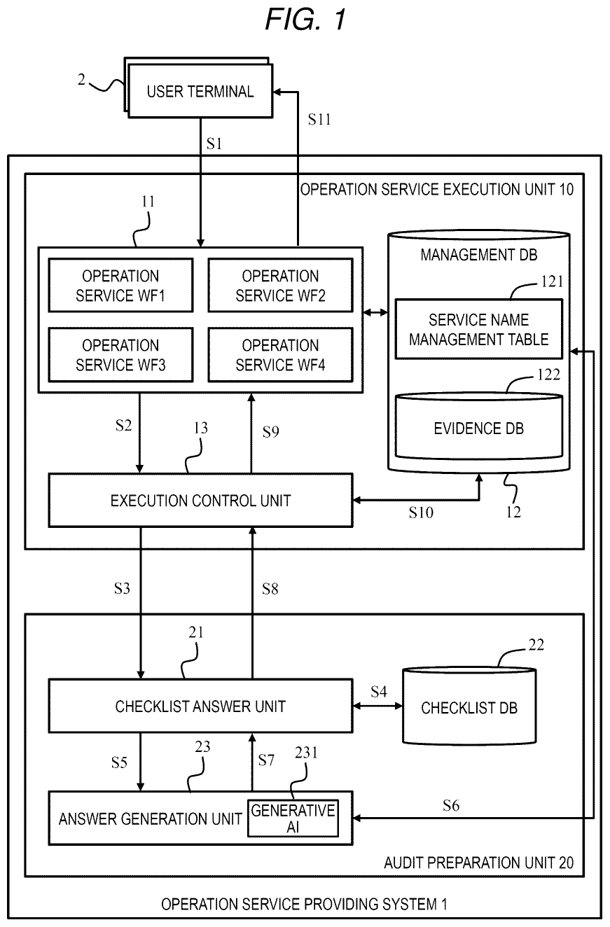

A first embodiment will be described with reference to FIGS. 1 to 21. In the present embodiment, any operation service of at least one operation service registered in advance is selected as a prescribed operation service, and audit preparation is executed each time the operation service is executed. In the audit preparation, an answer to a checklist is associated with an evidence that supports the answer. Therefore, an audit can be smoothly conducted at a later date. In the present embodiment, when the operation service conforms to a prescribed standard, the execution of the operation service is approved, and rejected in other cases. Therefore, it is possible to execute only an operation service conforming to a standard from around the day, and reliability of daily business can be improved.

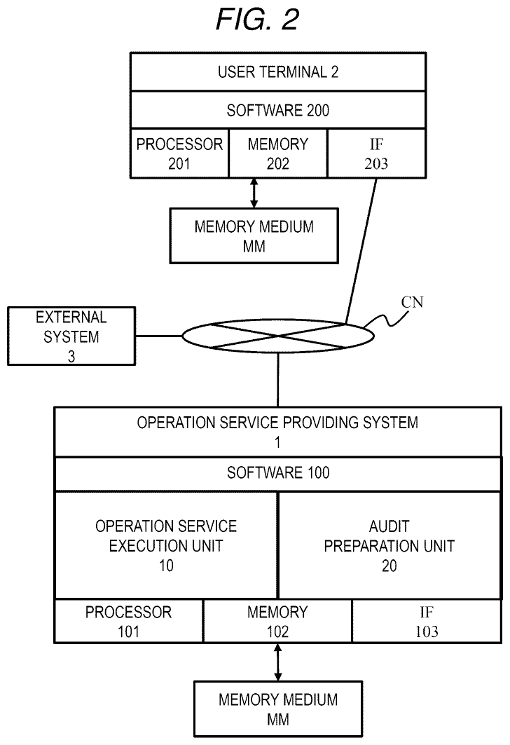

FIG. 1 is a configuration diagram showing functions of an operation service providing system 1. FIG. 2 is a hardware structure diagram of the operation service providing system 1.

The operation service providing system 1 includes, for example, an operation service execution unit 10 that executes an operation service and an audit preparation unit 20 that executes audit preparation. As shown in FIG. 2, the operation service providing system 1 is communicably connected to a user terminal via a communication network CN. As shown in FIG. 2, the operation service providing system 1 is also communicably connected to an external system 3 via the communication network CN.

Reference is made to FIG. 2 first. The operation service providing system 1 is constructed on a computer including hardware such as a processor 101, a memory 102, and an interface 103, and software 100. The software 100 such as an operating system and a computer program is stored in the memory 102, but is displayed separately from the memory 102 in FIG. 2.

The functions of the operation service providing system 1 are implemented by the processor 101 executing computer programs stored in the memory 102. The processor 101 is not limited to a central processing unit (CPU), and may include a graphics processing unit (GPU) or an application specific integrated circuit (ASIC).

The operation service providing system 1 is connectable to a memory medium MM. The memory medium MM is implemented by a memory device, a hard disk device, an optical disk device, a magneto-optical disk device, a magnetic tape device, and the like, and non-temporarily stores computer programs and data. The memory medium MM can transfer the computer programs and the data to the memory 102 of the operation service providing system 1 for storage. The computer programs and the data can also be transferred from the memory 102 to the memory medium MM for storage. By storing the computer programs for implementing the functions of the operation service providing system 1 in the memory medium MM, connecting the memory medium MM to another computer, and installing the computer programs stored in the memory medium MM in the other computer, the other computer can function as the operation service providing system 1.

The interface (abbreviated as IF in the figures) 103 includes, for example, a communication interface, an input and output interface, and a user interface.

The communication network CN may be a public communication network such as the Internet or a dedicated communication network. The communication network CN may be either a wireless communication network or a wired communication network, or a mixture of the wireless communication network and the wired communication network.

The user terminal 2 is a computer used by a user of the operation service providing system 1. The user terminal 2 includes hardware such as a processor 201, a memory 202, and an interface 203, and software 200.

The user terminal 2 is implemented by, for example, a desktop personal computer, a laptop personal computer, a tablet personal computer, or a wearable personal computer. Examples of the wearable personal computer include a glass personal computer and a wristwatch personal computer. In order for the user terminal 2 to exchange information with the user, a technique known as so-called virtual reality (VR), augmented reality (AR), mixed reality (MR), or extended reality (XR) may be used. The user terminal 2 has substantially the same hardware structure as the hardware structure of the operation service providing system 1, and thus further description will be omitted.

The external system 3 shown in FIG. 2 is a computer other than the operation service providing system 1, such as various servers and a network storage.

Return to FIG. 1. As described above, the functions of the operation service providing system 1 are roughly divided into the operation service execution unit 10 and the audit preparation unit 20.

The operation service execution unit 10 includes, for example, a service selection unit 11, a management database 12, and an execution control unit 13.

The service selection unit 11 is an example of an “operation service selection unit”. At least one operation service WF1 to WF4 is registered in the service selection unit 11 in advance. FIG. 1 shows an example in which four operation services are registered in the service selection unit 11, and three or less operation services or five or more services may be registered.

The management database 12 stores, for example, an operation service management table 121 and an evidence database 122.

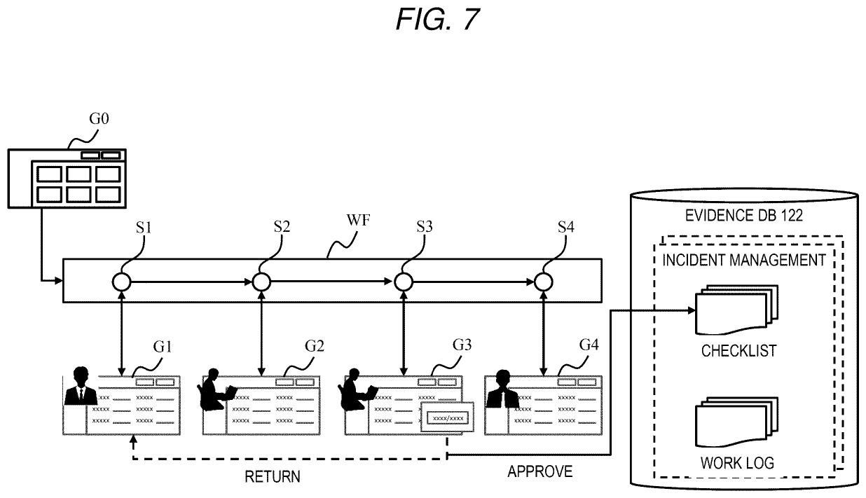

The execution control unit 13 controls execution of an operation service. For example, as will be described later with reference to FIG. 7, the execution control unit 13 controls the execution of the operation service such that the operation service is executed in stages according to prescribed procedures.

The audit preparation unit 20 includes, for example, a checklist answer unit 21, a checklist database 22, and an answer generation unit 23. The checklist answer unit 21 generates, by the answer generation unit 23, an answer to a checklist prepared for each standard, and automatically answers the operation service execution unit 10.

The checklist database 22 stores the checklist for each standard.

The answer generation unit 23 includes a generative artificial intelligence model (hereinafter, generative AI) 231. The generative AI 231 is, for example, a model in which a set of a prompt and an appropriate answer to a checklist is learned in advance.

The checklist answer unit 21 gives an action corresponding to a log of a prescribed operation service and a method for specifying an audit evidence to the answer generation unit 23 as a prompt for each prescribed keyword included in a check content of the checklist.

A detailed operation of the operation service providing system 1 will be described later. First, an outline of an overall operation of the operation service providing system 1 will be described.

The user accesses the operation service selection unit 11 to select a desired operation service, and starts a workflow of the selected operation service (S1). When the workflow is started, the execution control unit 13 registers work to be executed by the user in the management database 12 (S2), and requests the audit preparation unit 20 to execute an inspection (S3).

When receiving the request from the execution control unit 13, the checklist answer unit 21 of the audit preparation unit 20 acquires, from the checklist database 22, a checklist for a standard corresponding to the operation service instructed from the execution control unit 13 (S4). The checklist answer unit 21 generates a prescribed prompt and requests the answer generation unit 23 to answer the acquired checklist (S5).

Upon receiving the prescribed prompt, the generative AI 231 of the answer generation unit 23 searches the evidence database 122 for an evidence related to the standard corresponding to the operation service to be executed by the user (S6). The generative AI 231 transmits an answer to the checklist to the checklist answer unit with a basis (S7). The answer to the checklist is abbreviated as a checklist answer.

The checklist answer unit 21 determines whether the operation service desired by the user can be executed based on the checklist answer with a basis, and transmits a determination result to the execution control unit 13 (S8).

When the answer received from the answer generation unit 23 is an appropriate answer, the checklist answer unit 21 approves the execution of the operation service instructed by the user. The appropriate answer is an answer appropriate as an answer to the checklist, and corresponds to a “prescribed answer”. On the other hand, when the answer received from the answer generation unit 23 is not an appropriate answer, the checklist answer unit 21 rejects the execution of the operation service instructed by the user. “Rejecting the execution of the operation service” is one example of “not approving the execution of the operation service”. “Not approving the execution of the operation service” can be rephrased as “prohibiting the execution of the operation service”, “suspending the execution of the operation service”, “temporarily suspending the execution of the operation service”, and the like. That is, when it is determined that the checklist answer is not appropriate, the checklist answer unit 21 does not execute, by the execution control unit 13, the operation service instructed by the user.

The execution control unit 13 executes or does not execute the operation service according to a determination result of the checklist answer unit 21 (S9). When executing the operation service instructed by the user, the execution control unit 13 stores information on the execution of the operation service in the evidence database 122 (S10).

The operation service execution unit 10 notifies the user terminal 2 that the operation service is executed (S11).

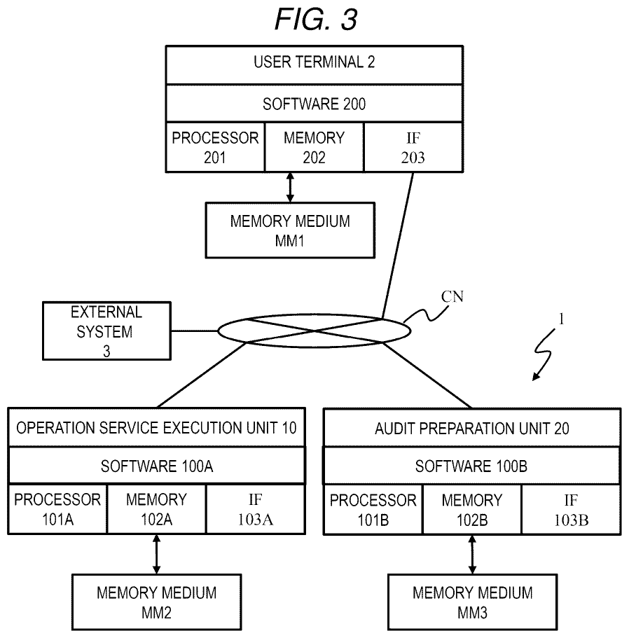

FIG. 3 shows a modification of the hardware structure of the operation service providing system 1. The operation service providing system 1 may be implemented by causing a computer provided with the operation service execution unit 10 to cooperate with a computer provided with the audit preparation unit 20. The computer provided with the operation service execution unit 10 includes, for example, a processor 101A, a memory 102A, various interfaces 103A, and software 100A. The computer provided with the audit preparation unit 20 also includes a processor 101B, a memory 102B, various interfaces 103B, and software 100B.

The software 100A is a computer program that implements a function as the operation service execution unit 10. The software 100B is a computer program that implements a function as the audit preparation unit 20. Description of hardware such as the processors 101A and 101B will be omitted.

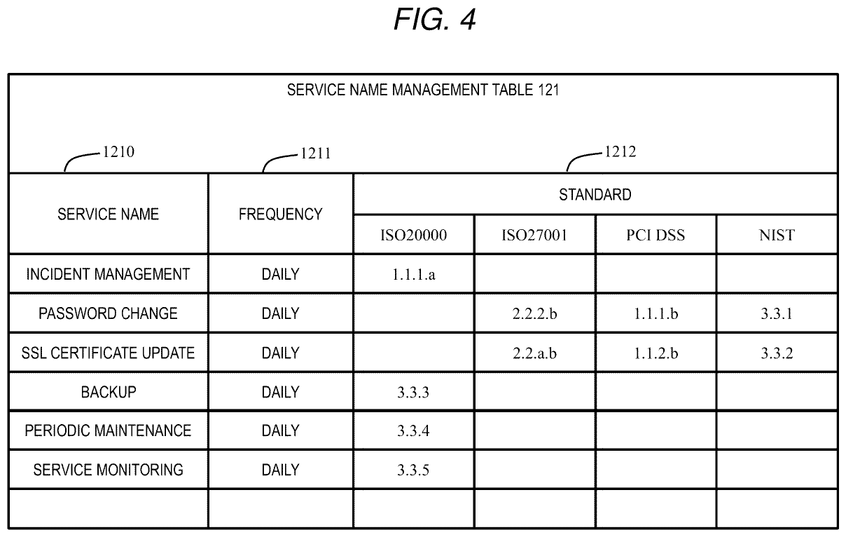

FIG. 4 shows an example of the operation service management table 121. The operation service management table 121 manages a plurality of operation services. The operation service management table 121 manages, for example, a service name 1210, a frequency 1211, and a standard 1212.

The service name 1210 is a name of an operation service. Examples of the operation service name include incident management, password management, SSL certificate update, backup, periodic maintenance, and service monitoring. The frequency 1211 indicates a frequency at which the operation service is executed. Examples of the frequency 1211 include “daily”, “every week”, “every month”, and “every quarter”. The standard 1212 indicates a standard corresponding to the operation service. Examples of the standard 1212 include ISO20000, ISO27001, PCIDSS, and NIST. Standard names shown in FIG. 4 are examples and are not limited to the shown examples.

The standard 1212 indicates which requirement among a plurality of requirements of each standard the operation service is associated with.

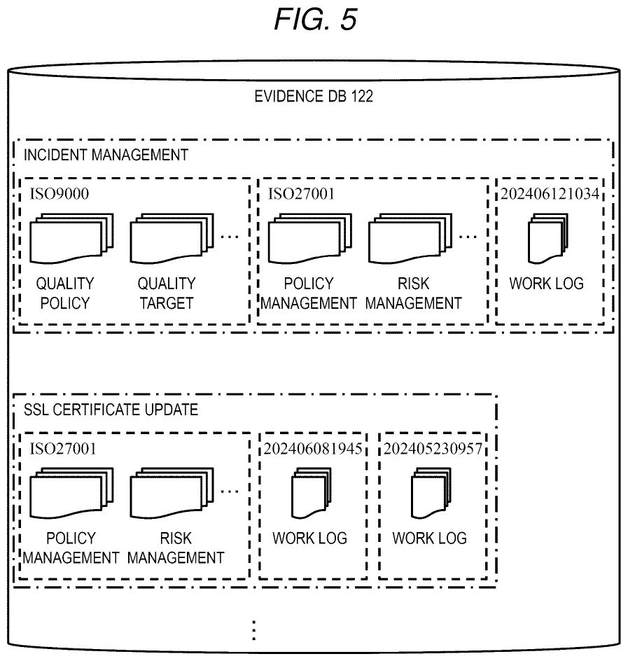

FIG. 5 is an example of storage contents of the evidence database 122. The evidence database 122 manages various data, for example, on an operation service basis. Examples of the various data include a quality policy, a quality target, policy management, risk management, and a work log.

FIG. 5 shows incident management and SSL certificate update as examples of the operation service. In a folder of incident management, for example, data of ISO9000, data of ISO 27001, and a work log acquired at 10:34 on Jun. 12, 2024 are associated with each other.

A subfolder ISO9000 that stores data related to ISO9000 associated with incident management includes, for example, a file indicating a quality policy and a file indicating a quality target. A subfolder ISO27001 that stores data related to ISO27001 associated with incident management includes, for example, a file indicating policy management and a file indicating risk management.

In a folder of SSL certificate update, for example, data of ISO27001 and a plurality of work logs acquired at different time points are associated with each other. A subfolder ISO27001 that stores data related to ISO27001 associated with SSL certificate update includes, for example, a file indicating policy management and a file indicating risk management.

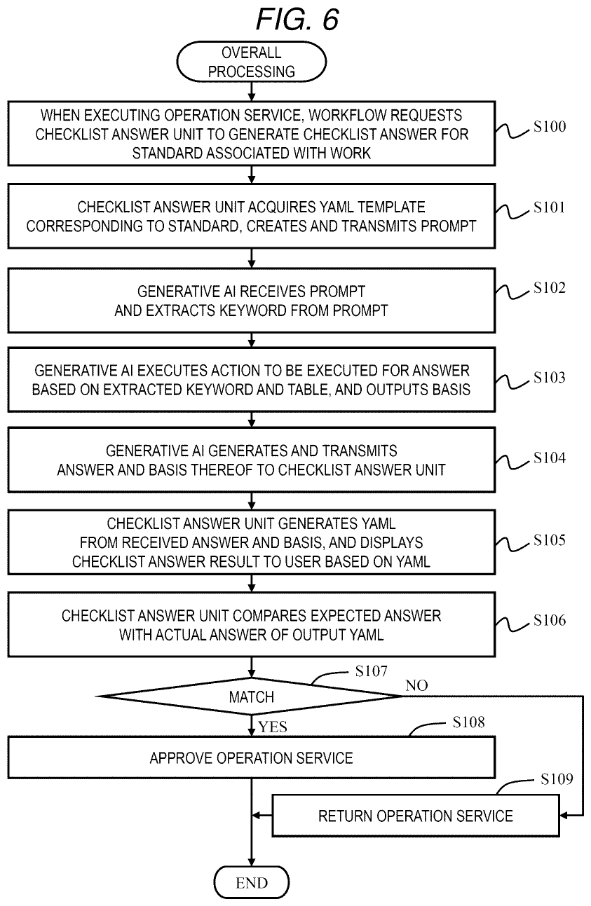

Overall processing executed by the operation service providing system 1 will be described with reference to a flowchart in FIG. 6.

When executing an operation service selected by the user, the operation service execution unit 10 requests the checklist answer unit 21 of the audit preparation unit 20 to generate an answer to a checklist for a standard corresponding to the operation service (S100).

The checklist answer unit 21 acquires a template corresponding to the checklist requesting an answer from the checklist database 22, creates a prompt using the template, and transmits the created prompt to the answer generation unit 23 (S101). The template corresponding to the checklist for the standard is created in a format such as YAML Ain't Markup Language (YAML).

When receiving the prompt from the checklist answer unit 21, the generative AI 231 of the answer generation unit 23 extracts a prescribed keyword from the prompt (S102). Examples of the prescribed keyword include “created”, “restricted”, and “recorded”.

The generative AI 231 executes an action corresponding to the extracted prescribed keyword based on a table in which prescribed keywords are associated with prescribed actions in advance, and outputs a basis that is a result of the action execution (S103).

The generative AI 231 generates an answer to the checklist for the standard requested from the checklist answer unit 21 and a basis (evidence) supporting the answer, and transmits the answer and the basis to the checklist answer unit 21 in association with each other (S104).

The checklist answer unit 21 generates YAML from the answer and the basis received from the answer generation unit 23, generates a checklist answer result based on the YAML, and transmits the checklist answer result to the user terminal 2 (S105). At this time, no work (work on the workflow) of the operation service desired by the user is executed.

The checklist answer unit 21 compares an expected answer with the answer output from the generative AI 231 (S106), and determines whether the two answers match (S107). That is, the checklist answer unit 21 determines whether a work content of the user conforms to the standard associated with the work content.

When the answer generated by the generative AI 231 matches the expected answer (also referred to as a standard-conforming answer or an appropriate answer) (S107: YES), the checklist answer unit 21 approves the execution of the operation service desired by the user (S108). On the other hand, when the two answers do not match (S107: NO), the checklist answer unit 21 returns the execution of the operation service desired by the user (S109).

In other words, the workflow approves the execution when the work content on the workflow by the user conforms to the standard, and returns the execution when the work content on the workflow by the user does not conform to the standard. When returning the execution of the operation service, the user is notified of a message “this work content or procedure does not conform to ISO20000” or the like. The message indicating that the execution of the operation service is not approved is displayed on, for example, a monitor display (not shown) of the user terminal 2.

FIG. 7 shows a flow of procedures when an operation service is used. First, the user selects one operation service desired to be executed from an operation service selection screen G0 for selecting an operation service. A workflow WF of a certain operation service selected by the user transitions from the screen G0 to a screen G4 in accordance with stages from steps S1 to S4.

At least one operation service is registered in advance on the screen G0. As in another embodiment to be described later, the user can also register an additional operation service in the operation service providing system 1.

The screen G1 is a screen on which the user applies for use of an operation service. The screen G2 is a screen for confirming parameters input during use of the operation service. The screen G3 is a screen for confirming whether to execute the operation service. The screen G4 is a screen for finally approving the execution of the operation service.

For example, the application screen G1 is operated by the user. The parameter confirmation screen G2 is operated by the user or another user. The execution confirmation screen G3 is operated by the user, the another user, or a yet another user. The approval screen G4 is normally operated by a user other than the user.

In this manner, FIG. 7 shows screen transition and approval procedures when the user uses the operation service in the workflow WF. On the screen G1, the user requests the operation service providing system 1 to use an operation service. On the screen G2, parameters input by the user are confirmed. On the screen G3, whether the operation service can be executed is confirmed. On the screen G4, final approval is given to the execution of the operation service desired by the user.

In accordance with operations on the screens G1 to G4, the operation service providing system 1 refers to or updates a checklist or a log from the evidence database 122 for each stage of steps S1 to S4, and notifies the user of an approval result. When the approval result is returned, the user returns to the screen G1 and reviews the parameters or the like. Therefore, the user can use the operation service in conformity with the standard associated with the operation service.

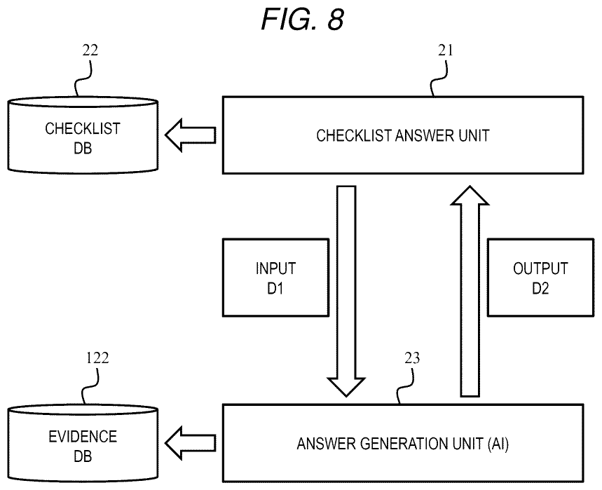

FIG. 8 shows an exchange between the checklist answer unit 21 and the answer generation unit 23 of the audit preparation unit 20. The checklist answer unit 21 passes, for example, contents of a checklist, keywords, and instructions of an action to the answer generation unit 23 as input information D1.

The answer generation unit 23 refers to the evidence database 122 and creates an answer and basis information using the generative AI 231. The answer generation unit 23 transmits the answer and the basis information to the checklist answer unit 21 as output information D2.

The checklist answer unit 21 determines whether contents (parameters or the like) input by the user conform to a standard based on the output information D2 received from the answer generation unit 23, and transmits a determination result to the operation service execution unit 10.

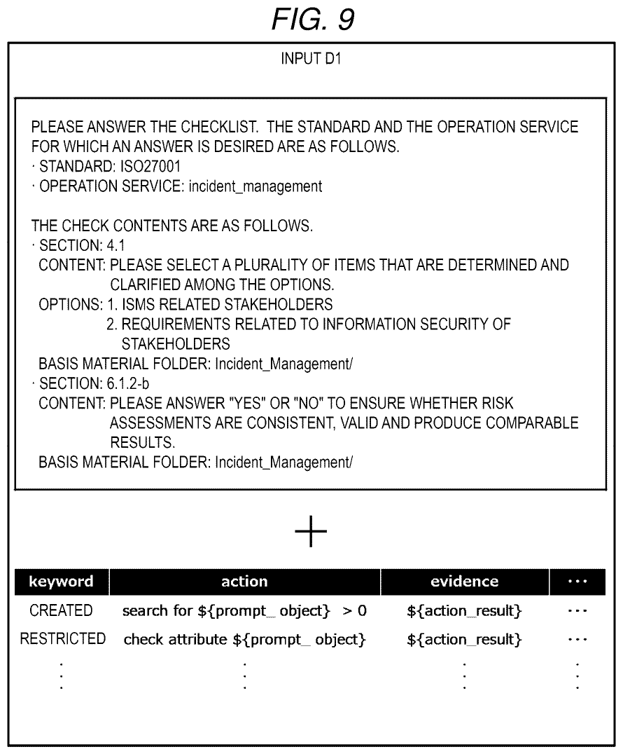

FIG. 9 shows an example of the input information D1. FIG. 9 shows information on a prompt that the checklist answer unit 21 passes to the answer generation unit 23. The prompt designates an audit target standard (ISO27001) and an operation service (incident_management). The prompt further indicates requirements related to a section “4.1” and a section “6.1.2-b” as check contents.

FIG. 9 shows, at a lower part thereof, an action table including columns such as “keyword”, “action”, and “evidence”. In the action table, an action to be executed, a method for specifying an evidence file, and the like are defined for each extracted prescribed keyword. The action table is input to the answer generation unit 23 together with the prompt. In this manner, the input information D1 includes keyword, requirement, path to evidence folder, and the like. Accordingly, the generative AI 231 of the answer generation unit 23 can generate an answer and an audit evidence in association with each other.

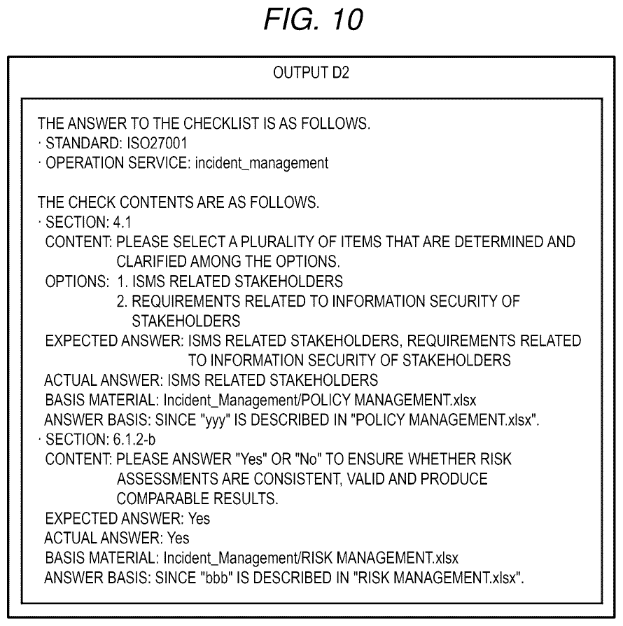

FIG. 10 shows an example of the output information D2. FIG. 10 shows an example of a checklist answer transmitted to the checklist answer unit 21 from the answer generation unit 23. Here, “section: 4.1” and “section: 6.1.2-b” are listed as check contents, and an expected answer and an actual answer are compared respectively. Further, in the output information D2, a file name such as “Incident_Management/POLICY MANAGEMENt.xlsx” and description contents in the file are also output as basis materials of the checklist answer. Accordingly, an auditor or a system administrator can easily confirm an evidence that supports validity of the answer, and usability is improved. When there is a problem in answer contents of the checklist, the auditor or the system administrator returns to the user without executing the operation service desired by the user. Therefore, the user can correct operation contents for the operation service while confirming the evidence. For this reason, the user can learn correct usage of the operation service substantially in real time, which efficiently improves user skills.

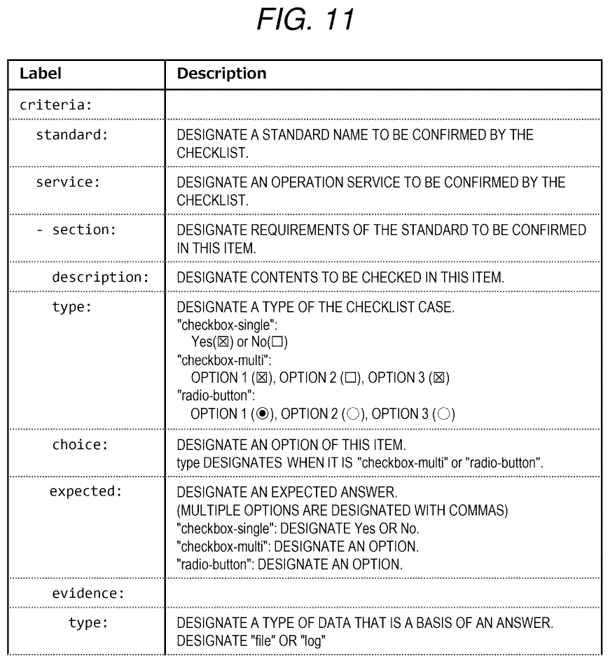

FIG. 11 shows an example of a template for a checklist. In the template for the checklist, correspondence between labels and descriptions is listed. The template includes elements such as “criteria:”, “standard:”, and “service:”.

For example, a standard name to be confirmed by the checklist is designated in “standard:”, and a name of an operation service to be confirmed by the checklist is designated in “service:”. In “type:”, a check method (checkbox-single, checkbox-multi, radio-button, and the like) is indicated, and an expected answer content is set in “expected:”. Further, “evidence:” indicates a type of a data file or a log file that is a basis of an answer, so that an evidence necessary for an audit can be systematically managed.

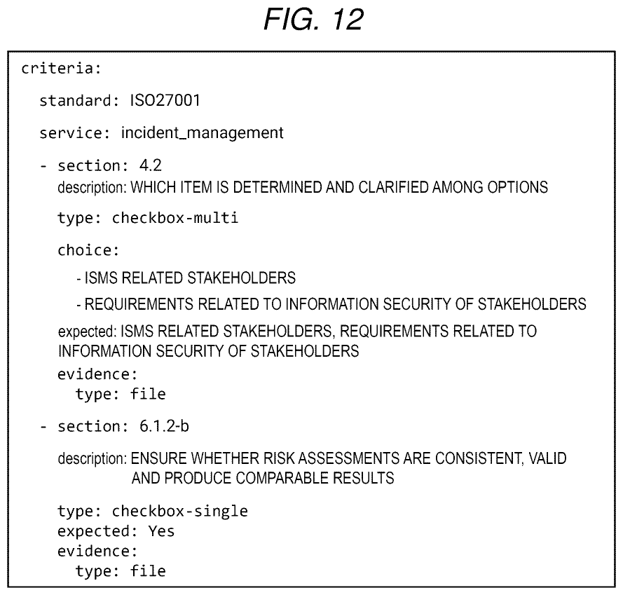

FIG. 12 shows an example of a checklist created using the template shown in FIG. 11. For example, elements such as “criteria:”, “standard: ISO27001”, and “service: incident_management” are defined, and requirements to be audited such as “-section: 4.2” and “-section: 6.1.2-b” are listed. In the section “4.2”, a format of “checkbox-multi” is designated, and “ISMS related stakeholders”, “requirements related to information security of stakeholders”, and the like are arranged as options, and a plurality of expected options are shown in “expected:”. In the section “6.1.2-b”, “Yes” is designated as an expected answer for “checkbox-single”, and a file type of an evidence is designated as “file”. Accordingly, the checklist answer unit 21 can easily generate an answer in a format conforming to the template, and the generative AI 231 of the answer generation unit 23 can easily determine what type of evidence is to be associated with which item.

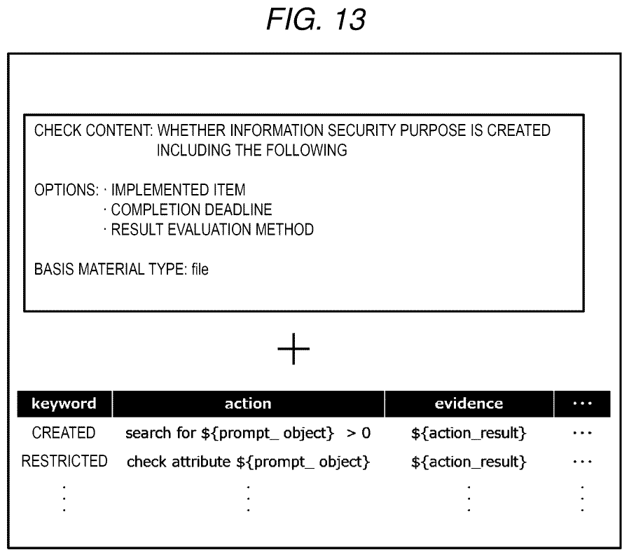

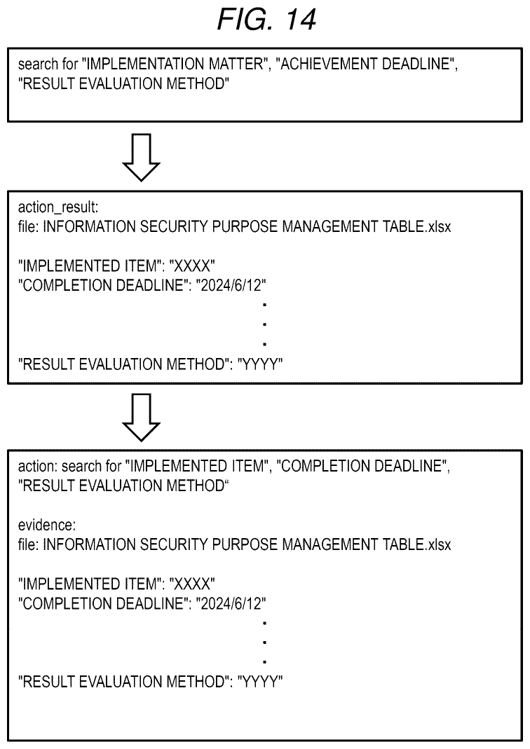

FIG. 13 shows procedures for extracting a prescribed keyword from a check content of a checklist and executing an action corresponding to the extracted prescribed keyword. The procedures shown in FIGS. 13 and 14 are executed by the generative AI 231 based on the checklist.

Here, a question “whether an information security purpose is created including the following” is shown as the check content. For example, “IMPLEMENTED ITEM”, “COMPLETION DEADLINE”, and “RESULT EVALUATION METHOD” are shown as options. In FIG. 13, a type of an audit evidence is designated as “file”.

FIG. 13 shows an example of the above-described action table on a lower side thereof. The action table manages a prescribed keyword, an action associated with the prescribed keyword, and an evidence material (audit evidence) associated with the prescribed keyword.

For example, when a prescribed keyword “created” is detected from a prompt, the generative AI 231 searches for an evidence indicating a created result. When a prescribed keyword “restricted” is detected from the prompt, the generative AI 231 finds that an action of the system is restricted and finds an evidence thereof.

FIG. 14 shows an action execution result created by the procedures shown in FIG. 13. In this example, as a result of executing an action of “search for ‘IMPLEMENTED ITEM’, ‘COMPLETION DEADLINE’, and ‘RESULT EVALUATION METHOD’”, information such as “XXXX” as the implemented item, “2024/6/12” as the completion deadline, and “YYYY” as the result evaluation method is present in a file “INFORMATION SECURITY PURPOSE MANAGEMENT TABLE.xlsx”. The generative AI 231 of the answer generation unit 23 outputs these pieces of information as an audit evidence. The checklist answer unit 21 clarifies which cell of the file output as the audit evidence includes the keyword. Accordingly, the checklist answer unit 21 assists audit work in advance so that the auditor or the system administrator can easily verify the evidence.

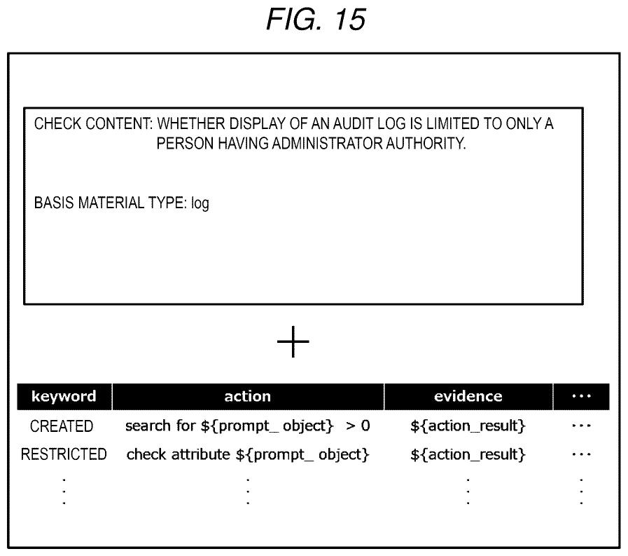

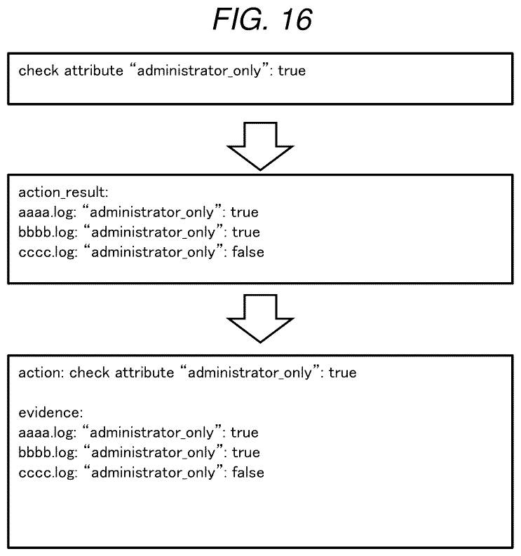

FIGS. 15 and 16 show examples different from the examples in FIGS. 13 and 14. The generative AI 231 extracts a prescribed keyword from a check content included in a prompt, executes an action associated with the extracted prescribed keyword, and outputs presence of an audit evidence as an execution result.

FIG. 15 shows a check content of “whether display of an audit log is limited only to a person having administrator authority”, and a type (for example, a log) of a material that is a basis for the check content.

Since the check content includes a prescribed keyword “restricted”, the generative AI 231 confirms a behavior of the operation service based on the action table and acquires the confirmation result as an evidence. In a case of a log file, the generative AI 231 verifies whether viewing authority is restricted as expected by confirming a file attribute and a log content.

FIG. 16 shows a result of an action executed in the procedures shown in FIG. 15. In FIG. 16, when an action “check attribute ‘administrator_only’: true” is executed, “aaaa.log” and “bbbb.log” are displayed only to the administrator, but “cccc.log” is displayed to other than the administrator, indicating that the action is violated.

The answer generation unit 23 outputs this result as “action_result” and further adds information that is an evidence. The checklist answer unit 21 transmits the answer result to the operation service execution unit 10. In this manner, the checklist answer unit 21 associates the action execution result with the evidence, and thus can immediately determine whether an access restriction of the log file is appropriately executed or whether there is a defect and the return is necessary.

The above is description of FIGS. 13 to 16. Each of the figures shows a flow in which the answer generation unit 23 analyzes a prompt received from the checklist answer unit 21 and automatically searches for or verifies an evidence according to a prescribed keyword.

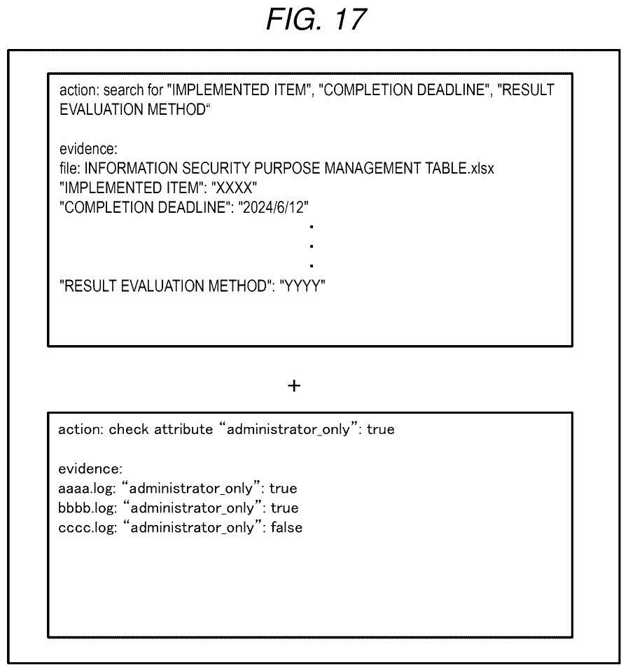

FIG. 17 shows procedures for generating a checklist answer including an action executed by the generative AI 231 and an evidence that is a basis for the action. FIG. 17 indicates, on an upper side thereof, that corresponding information (“XXXX”, “2024/6/12”, and “YYYY”) is present in the file “INFORMATION SECURITY PURPOSE MANAGEMENT TABLE.xlsx” as “action: search for ‘IMPLEMENTED ITEM’, ‘COMPLETION DEADLINE’, and ‘RESULT EVALUATION METHOD’”.

FIG. 17 shows, on a lower side thereof, a result of confirming attribute information in a log file (aaaa.log, bbbb.log, cccc.log) as “action: check attribute ‘administrator_only’: true” as an evidence. In this manner, a plurality of actions and evidences can be collectively shown in one checklist answer in the present embodiment, and thus work efficiency of audit preparation by an audit manager or a system administrator is improved.

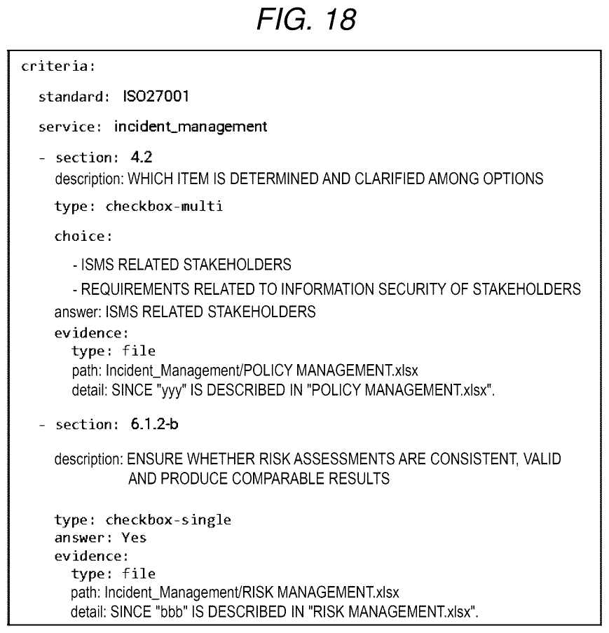

FIG. 18 shows an example of a checklist answer generated according to the procedures in FIG. 17. The generative AI 231 checks whether the operation service (service: incident_management) conforms to a standard (standard: ISO27001), and sends a result thereof to the checklist answer unit 21 together with the evidence. The checklist answer unit 21 converts an evidence-added answer received from the generative AI 231 into a YAML format, and transmits the answer to the operation service execution unit 10.

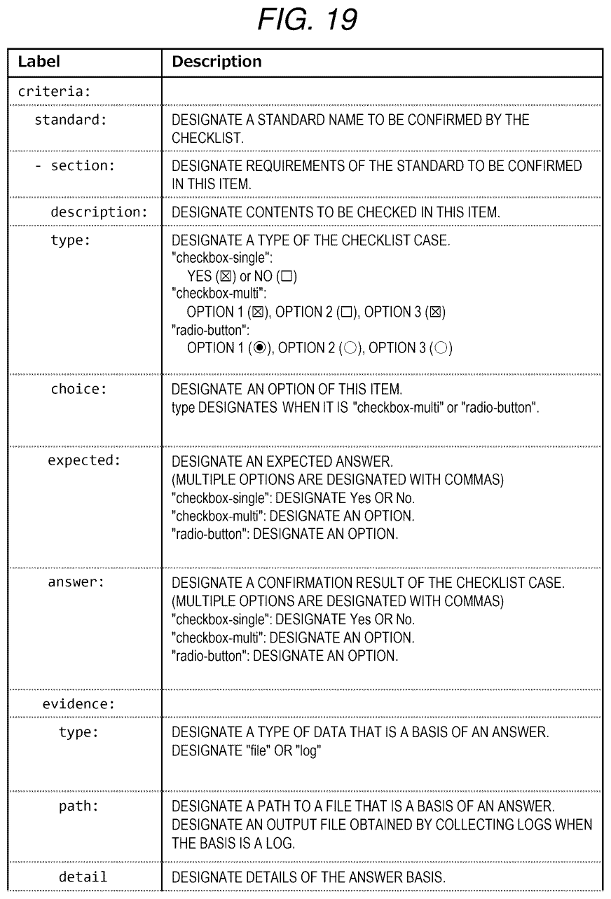

FIG. 19 shows a template definition indicating an item structure of a checklist. As correspondence between labels and description, “criteria:”, “standard:”, “section:”, “description:”, “type:”, “choice:”, “expected:”, “answer:”, “evidence:”, and the like are exemplified, and meanings thereof are shown. For example, “answer:” is an item indicating a confirmation result of a checklist case, and “Yes” or “No” can be designated in a case of checkbox-single, and multiple options can be separated with commas in a case of checkbox-multi. By using lower elements of “evidence:” such as “type:”, “path:”, and “detail:”, a location of a file and a log content that are bases of the answer can be managed in detail.

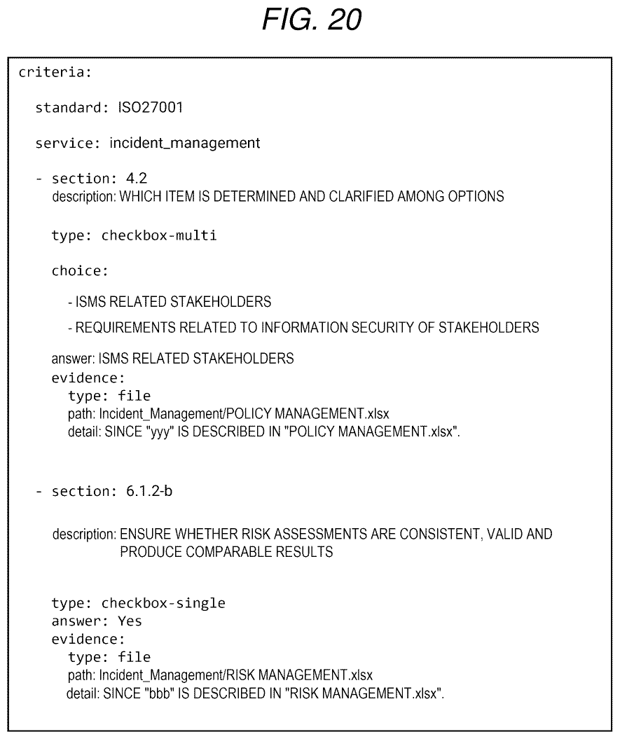

FIG. 20 is an example of a checklist created based on the template definition shown in FIG. 19. In the section “4.2”, “checkbox-multi” is designated, and “ISMS related stakeholders” and “requirements related to information security of stakeholders” are arranged as options. Then, as an actual answer, “ISMS related stakeholders” is selected. As an evidence, a type is “file” and “yyy” is described in “Incident_Management/POLICY MANAGEMENT.xlsx”. Further, in the section “6.1.2-b”, “Yes” is selected as “checkbox-single”, and “bbb” is described in “RISK MANAGEMENT.xlsx” as a basis thereof. Accordingly, in the present embodiment, the answer and the actually extracted evidence are associated on one checklist. Therefore, in the present embodiment, audit preparation work by the audit preparation unit 20 can be smoothly and efficiently executed, and further, the user can be trained to appropriately use the operation service.

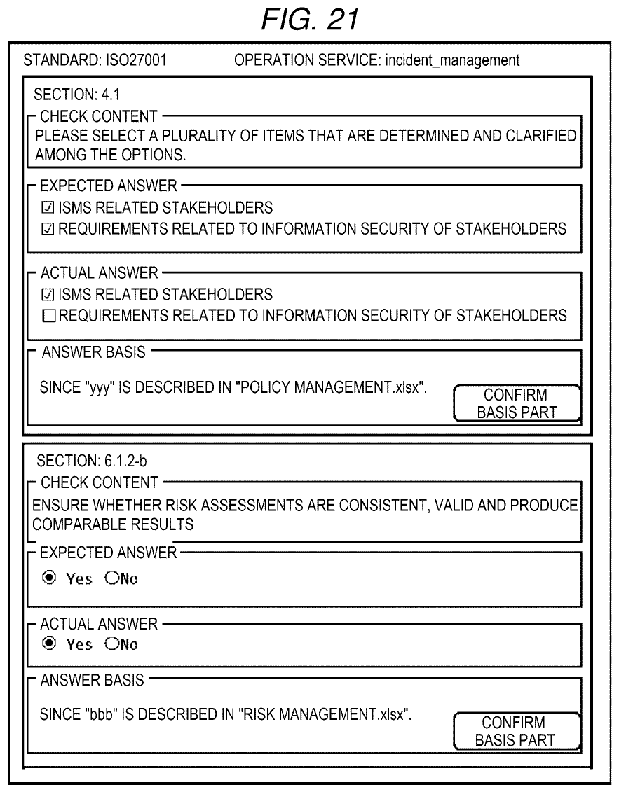

FIG. 21 shows an example of a checklist answer result presented to the user by the checklist answer unit 21. The checklist answer unit 21 generates a checklist answer result in a form easy to understand for the user based on data in the YAML format passed from the generative AI 231, and transmits the generated checklist answer result to the user terminal 2.

FIG. 21 shows an answer result of a checklist related to a relationship between a standard (ISO27001) and an operation service (incident_management). FIG. 21 shows contents generated by the checklist answer unit 21 for the section “4.1” and the section “6.1.2-b”.

What can be read by those skilled in the art from not only FIG. 21 but also all the drawings referred to in the present embodiment is a part of disclosed contents according to the present embodiment. Items that can be read from the drawings by those skilled in the art include not only items that can be directly read by those skilled in the art but also items that are conceptualized from the items that can be directly read.

In the operation service providing system 1 having the above configuration according to the present embodiment, when using an operation service, the user confirms whether the operation service is operating in conformity with a prescribed standard and performs audit preparation. The operation service providing system 1 according to the present embodiment can assist work preparation for a later audit while providing an operation service to the user.

The operation service providing system 1 according to the present embodiment not only can confirm whether the operation service conforms to the prescribed standard while providing the operation service to a user, but also collects an evidence indicating that the operation service conforms to the prescribed standard. Therefore, the audit preparation can be efficiently performed, and burden on the auditor or the like can be reduced.

The operation service providing system 1 according to the present embodiment automatically generates a checklist for confirming whether the operation service conforms to the prescribed standard, and associates an evidence with the checklist. Therefore, the auditor or the system administrator can compare and easily confirm an answer to the checklist and an evidence supporting the answer, and efficiency of audit work is improved.

In the present embodiment, the checklist answer unit 21 inputs not only a prompt requesting an answer to the checklist but also an action requesting a search or collection of an evidence supporting the answer to the generative AI 231. Therefore, the generative AI 231 can output the answer to the checklist and the evidence in association with each other.

The audit preparation unit 20 according to the present embodiment confirms whether the operation service used by the user conforms to the prescribed standard substantially in real time and notifies the operation service execution unit 10 of the result, and thus the operation service execution unit can prevent execution of an operation service not conforming to the prescribed standard and request the user to review.

The operation service providing system 1 according to the present embodiment can manage a plurality of operation services, and thus the management database 12 and the audit preparation unit 20 can be shared among the plurality of operation services. Therefore, the operation service providing system 1 can provide and manage a plurality of operation services by efficiently using computer resources.

The operation service providing system 1 according to the present embodiment can be implemented as a so-called on-premises system or a so-called cloud service. In either case, the operation service providing system 1 according to the present embodiment can use a common workflow even when a plurality of sites or a plurality of users are involved, and can perform consistent audit preparation.

### Embodiment 2

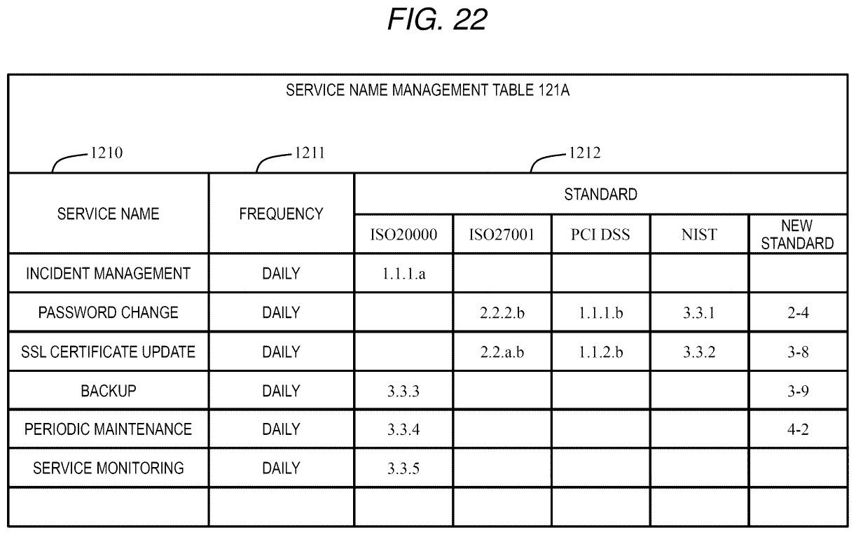

Embodiment 2 will be described with reference to FIGS. 22 to 25. In the following embodiments including the present embodiment, differences from Embodiment 1 will be mainly described. The present embodiment will describe a case where the system administrator or the like adds another standard to the operation service providing system 1.

FIG. 22 shows an example of an operation service management table 121A used by the operation service providing system 1 according to Embodiment 2.

As described with reference to FIG. 4, the operation service management table 121A holds information such as the service name 1210, the frequency 1211, and the standard 1212, and visualizes requirements of which standard each operation service corresponds to. In the present embodiment, the operation service providing system 1 can cope with adding and changing a standard compatible with the operation service providing system 1.

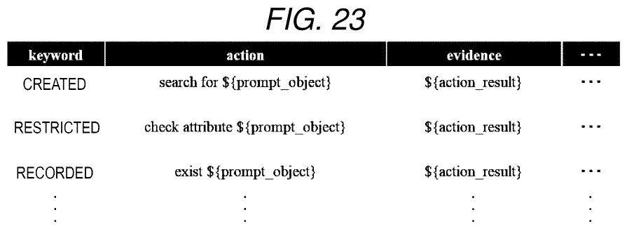

FIG. 23 shows an example of an action table. When an additional action is included in actions to be executed under a new standard, the additional action is added to the action table. In the example of FIG. 23, an operation and an evidence related to an action are registered in the action table for a prescribed keyword “recorded”.

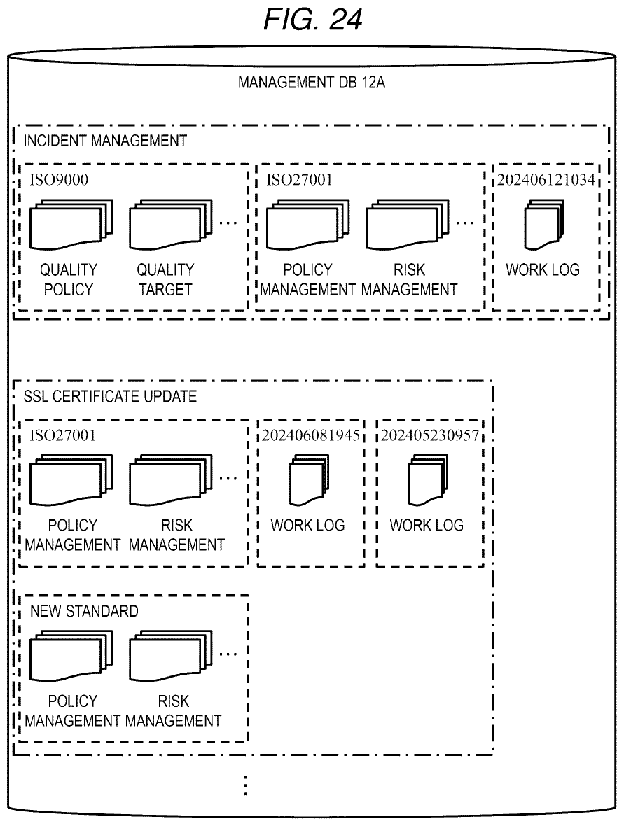

FIG. 24 shows an example of a management database 12A. As described in FIG. 5, the management database 12A stores the operation service management table 121A, the evidence database 122, and the like. FIG. 24 further shows, on a lower side thereof, information on other standards (for example, “policy management” and “risk management”).

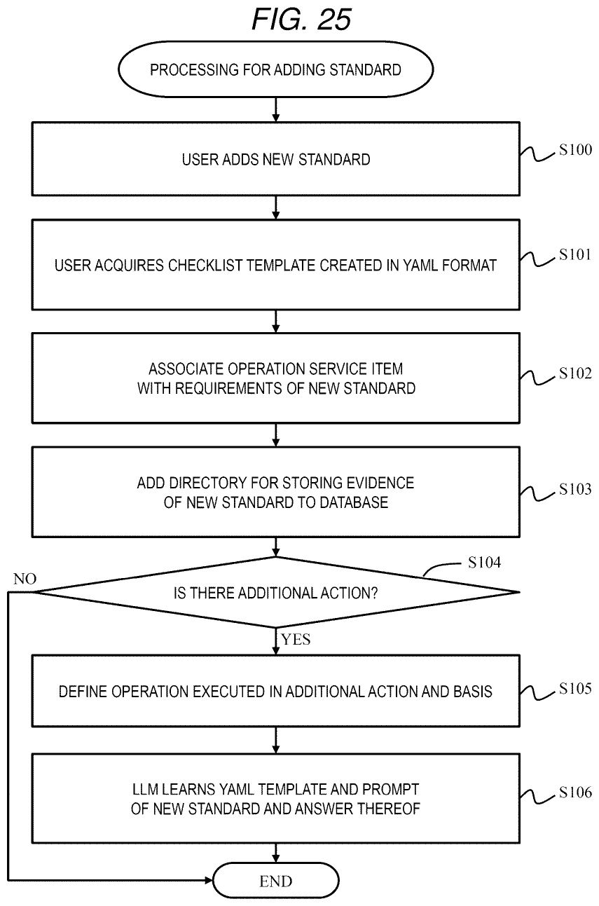

FIG. 25 is a flowchart showing procedures for adding another standard to the operation service providing system 1. First, in step S100, the user performs an operation of adding a new standard to the operation service providing system 1. In step S101, a checklist template created by the user in the YAML format is acquired. In step S102, association between requirements of the new standard and an operation service item is set. In step S103, a directory for storing an evidence of the new standard is added to the database.

In step S104, it is determined whether there is an action to be additionally set, and when there is an action to be additionally set (S104: YES), an operation and a basis corresponding to the additional action are defined in step S105.

Finally, in step S106, a YAML template and a prompt of the new standard and an answer thereof are learned by the generative AI 231 (for example, LLM: Large Language Models), and the processing is finished.

The present embodiment configured as described above also exhibits the same effects as those in Embodiment 1. Further, in the present embodiment, the user can freely add and edit a standard, audit preparation and an action corresponding to a new standard can be updated or expanded, and usability for the user of the operation service providing system 1 is improved.

### Embodiment 3

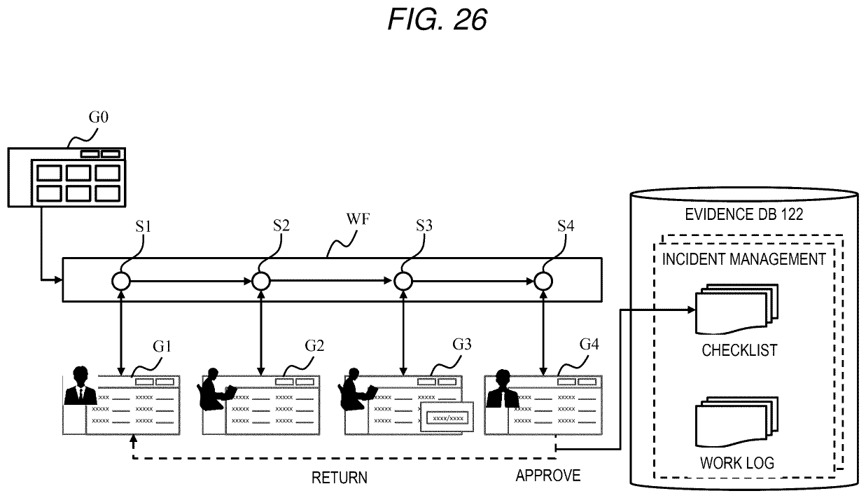

Embodiment 3 will be described with reference to FIG. 26. In the present embodiment, it is determined whether to approve use of an operation service on the approval screen G4.

FIG. 26 shows screen transition and approval procedures when the user uses an operation service in the workflow WF as described in FIG. 7. On the screen G1, the user requests the operation service providing system 1 to use an operation service. On the screen G2, parameters input by the user are confirmed. On the screen G3, whether the operation service can be executed is preliminarily confirmed. On the screen G4, final approval is given to the execution of the operation service desired by the user.

The present embodiment configured as described above also exhibits the same effects as those in Embodiment 1.

The invention is not limited to the embodiments described above, and includes various modifications. For example, the embodiments described above have been described in detail to facilitate understanding of the invention, and the invention is not necessarily limited to those including all the configurations described above. A part of a configuration in one embodiment can be replaced with a configuration in another embodiment, and a configuration in one embodiment can also be added to a configuration in another embodiment. A part of a configuration in each embodiment may be added to, deleted from, or replaced with another configuration.

The embodiments described above disclose the inventions expressed as follows.

(Appendix 1) An operation service providing system that provides a prescribed operation service includes: an operation service execution unit configured to control execution of the prescribed operation service; and an audit preparation unit configured to execute a prescribed audit preparation work in preparation for an audit work for auditing whether the prescribed operation service is executed based on a prescribed standard, in which the audit preparation unit executes the prescribed audit preparation work for the prescribed operation service each time the operation service execution unit executes the prescribed operation service.

(Appendix 2) In the operation service providing system according to Appendix 1, the prescribed audit preparation work includes collection and storage of an audit evidence indicating that the prescribed operation service is executed based on the prescribed standard.

(Appendix 3) In the operation service providing system according to Appendix 1 or 2, the prescribed audit preparation work includes an answer to a prescribed checklist corresponding to the prescribed standard.

(Appendix 4) In the operation service providing system according to any one of Appendixes 1 to 3, the prescribed audit preparation work includes collection of an audit evidence indicating that the prescribed operation service is executed based on the prescribed standard and an answer to a prescribed checklist corresponding to the prescribed standard, and the audit evidence is associated with the checklist.

(Appendix 5) In the operation service providing system according to any one of Appendixes 1 to 4, the audit preparation unit includes a checklist answer unit that answers the checklist and an answer generation unit that includes a generative artificial intelligence model in which a set of a prompt and the answer to the checklist is learned in advance, and the checklist answer unit gives, as the prompt, an action corresponding to a log of the prescribed operation service and a method for specifying the audit evidence to the answer generation unit for each prescribed keyword included in a check content of the checklist.

(Appendix 6) In the operation service providing system according to any one of Appendixes 1 to 5, the audit preparation unit notifies the operation service execution unit of whether the prescribed operation service is executable based on an answer from the answer generation unit.

(Appendix 7) In the operation service providing system according to any one of Appendixes 1 to 6, the audit preparation unit approves execution of the prescribed operation service by the operation service execution unit when the answer from the answer generation unit is a prescribed answer, and does not approve execution of the prescribed operation service by the operation service execution unit when the answer from the answer generation unit is not the prescribed answer.

(Appendix 8) The operation service providing system according to any one of Appendixes 1 to 7 further includes an operation service selection unit in which a plurality of operation services are registered, in which the operation service execution unit treats an operation service selected by the operation service selection unit as the prescribed operation service.

(Appendix 9) An operation service providing method for controlling an operation service providing system that provides a prescribed operation service includes: an operation service execution step of controlling execution of the prescribed operation service; and an audit preparation step of executing a prescribed audit preparation work in preparation for an audit work for auditing whether the prescribed operation service is executed based on a prescribed standard, in which in the audit preparation step, the prescribed audit preparation work for the prescribed operation service is executed each time the prescribed operation service is executed in the operation service execution step.

(Appendix 10) In the operation service providing method according to Appendix 9, the prescribed audit preparation work includes collection and storage of an audit evidence indicating that the prescribed operation service is executed based on the prescribed standard.

(Appendix 11) In the operation service providing method according to Appendix 9 or 10, the prescribed audit preparation work includes an answer to a prescribed checklist corresponding to the prescribed standard.

(Appendix 12) In the operation service providing method according to any one of Appendixes 9 to 11, the prescribed audit preparation work includes collection of an audit evidence indicating that the prescribed operation service is executed based on the prescribed standard and an answer to a prescribed checklist corresponding to the prescribed standard, and the audit evidence is associated with the checklist.

(Appendix 13) In the operation service providing method according to any one of Appendixes 9 to 12, in the audit preparation step, an action corresponding to a log of the prescribed operation service and a method for collecting the audit evidence is output as a prompt for each prescribed keyword included in a check content of the checklist, and the prompt is input to a generative artificial intelligence model in which a set of the prompt and the answer to the checklist is learned in advance, and an answer output from the generative artificial intelligence model corresponding to the input prompt is the answer to the checklist.

What is claimed is:

1. An operation service providing system that provides a prescribed operation service, the operation service providing system comprising:
an operation service execution unit configured to control execution of the prescribed operation service; and
an audit preparation unit configured to execute a prescribed audit preparation work in preparation for an audit work for auditing whether the prescribed operation service is executed based on a prescribed standard, wherein
the audit preparation unit executes the prescribed audit preparation work for the prescribed operation service each time the operation service execution unit executes the prescribed operation service.

2. The operation service providing system according to claim 1, wherein
the prescribed audit preparation work includes collection and storage of an audit evidence indicating that the prescribed operation service is executed based on the prescribed standard.

3. The operation service providing system according to claim 1, wherein
the prescribed audit preparation work includes an answer to a prescribed checklist corresponding to the prescribed standard.

4. The operation service providing system according to claim 1, wherein
the prescribed audit preparation work includes collection of an audit evidence indicating that the prescribed operation service is executed based on the prescribed standard and an answer to a prescribed checklist corresponding to the prescribed standard, and
the audit evidence is associated with the checklist.

5. The operation service providing system according to claim 4, wherein
the audit preparation unit includes a checklist answer unit that answers the checklist and an answer generation unit that includes a generative artificial intelligence model in which a set of a prompt and the answer to the checklist is learned in advance, and
the checklist answer unit gives, as the prompt, an action corresponding to a log of the prescribed operation service and a method for specifying the audit evidence to the answer generation unit for each prescribed keyword included in a check content of the checklist.

6. The operation service providing system according to claim 5, wherein
the audit preparation unit notifies the operation service execution unit of whether the prescribed operation service is executable based on an answer from the answer generation unit.

7. The operation service providing system according to claim 6, wherein
the audit preparation unit approves execution of the prescribed operation service by the operation service execution unit when the answer from the answer generation unit is a prescribed answer, and does not approve execution of the prescribed operation service by the operation service execution unit when the answer from the answer generation unit is not the prescribed answer.

8. The operation service providing system according to claim 7, further comprising:
an operation service selection unit in which a plurality of operation services are registered, wherein
the operation service execution unit treats an operation service selected by the operation service selection unit as the prescribed operation service.

9. An operation service providing method for controlling an operation service providing system that provides a prescribed operation service, the operation service providing method comprising:
an operation service execution step of controlling execution of the prescribed operation service; and
an audit preparation step of executing a prescribed audit preparation work in preparation for an audit work for auditing whether the prescribed operation service is executed based on a prescribed standard, wherein
in the audit preparation step, the prescribed audit preparation work for the prescribed operation service is executed each time the prescribed operation service is executed in the operation service execution step.

10. The operation service providing method according to claim 9, wherein
the prescribed audit preparation work includes collection and storage of an audit evidence indicating that the prescribed operation service is executed based on the prescribed standard.

11. The operation service providing method according to claim 9, wherein
the prescribed audit preparation work includes an answer to a prescribed checklist corresponding to the prescribed standard.

12. The operation service providing method according to claim 9, wherein
the prescribed audit preparation work includes collection of an audit evidence indicating that the prescribed operation service is executed based on the prescribed standard and an answer to a prescribed checklist corresponding to the prescribed standard, and
the audit evidence is associated with the checklist.

13. The operation service providing method according to claim 12, wherein
in the audit preparation step, an action corresponding to a log of the prescribed operation service and a method for collecting the audit evidence is output as a prompt for each prescribed keyword included in a check content of the checklist, and
the prompt is input to a generative artificial intelligence model in which a set of the prompt and the answer to the checklist is learned in advance, and an answer output from the generative artificial intelligence model corresponding to the input prompt is the answer to the checklist.
